(19) United States
(12) Patent Application Publication
(10) Pub. No.: US 2012/0026088 A1
(43) Pub. Date: Feb. 2, 2012

(54) HANDHELD DEVICE WITH PROJECTED USER INTERFACE AND INTERACTIVE IMAGE

(75) Inventor: Charles Goran, Bellevue, WA (US)

(73) Assignee: T-Mobile USA, Inc., Bellevue, WA (US)

(21) Appl. No.: 12/848,193

(22) Filed: Aug. 1, 2010

(51) Int. Cl. G06F 3/033; H04N 5/64

(52) U.S. Cl. 345/158; 348/744; 348/E05.137

(57) ABSTRACT

Systems and methods for a device with a user interactive image projector disposed in a distal end of the device from the user are described. In one aspect, the device is operatively configured to project at least a portion of a user interactive image on a projection surface separate from the device. The device locks at least a portion of the projected user interactive image with respect to the projection surface. Responsive to receiving user input, the device allows the user to navigate the user interactive image in accordance with the user input.

### BACKGROUND

Wireless devices such as wireless phones, smartphones, handheld computing devices, personal digital assistants (PDAs), or the like typically employ a keyboard and/or an interactive, oftentimes haptic, display. In some such devices, a haptic display (e.g., a touchscreen) performs the function of both keyboard and display. The size of the display typically dictates at least a minimum physical size of such a wireless device. A large display provides a viewer a richer viewing experience and easier control of the device. A smaller display affords a more compact and portable device.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1a shows aspects of an exemplary device 100 for presenting a projected user interface and interactive image to a user or viewer, according to one embodiment.

FIG. 1b shows further exemplary aspects of a device 100 for presenting a projected user interface and interactive image to a user or viewer, according to one embodiment.

FIG. 2 shows an exemplary device projecting a user interactive image on a surface (e.g., a wall), according to various embodiments.

FIG. 3 diagrammatically illustrates an exemplary layout of components of a device, according to one embodiment. In particular, FIG. 3 shows computing device components of the device of FIG. 1a, FIG. 1b, and FIG. 2 in addition to a display.

FIG. 4 is a diagrammatic illustration of contents of memory of a device projecting a user interactive image, according to one embodiment.

FIG. 5 is a diagrammatic perspective view of a device projecting routing instructions, according to one embodiment.

FIG. 6 is a diagrammatic perspective view of a device projecting identification indicia, according to one embodiment.

FIG. 7 shows an example procedure for display and interaction with an interactive projected image, according to one embodiment.

FIG. 8 shows an example procedure for projecting a user interactive image, according to one embodiment.

FIG. 9 shows another example procedure for projecting a user interactive image, according to one embodiment.

FIG. 10 shows an example procedure for projecting location information, according to one embodiment.

### DETAILED DESCRIPTION

### Overview

The described systems and methods are directed to a mobile device that provides a projected image that is interactive in various implementations. The device is “mobile” in that it is readily portable. That is, the device is capable of being held and manipulated in one hand of a user, may be wearable, or otherwise sized for personal use. Various device embodiments allow a user to acquire, project, and navigate through such means as a haptic interface, a projected image, which might be a user interface (UI), a webpage of a website, a video, a photo, a photo album, or the like, on a remote display space that is independent of the device. The image may be projected onto a surface, which may be relatively flat, such as a wall, tabletop, floor or ceiling, for viewing by the device user and/or one or more other viewers, such as another individual or an audience. The device may allow a user to navigate to different portions of a displayed webpage and interface with user interface elements such as selecting a hyperlink or button control. The device may also allow the user to lock an image and display and interact with a portion of the image. In one embodiment, the device has a display that may mirror the user interactive image projection or present other info (e.g., notifications, etc.). In another embodiment, the device may be “displayless” in that the device itself does not have a screen, nor is it connected to a monitor or the like.

In accordance with various embodiments, the device comprises a processor operatively coupled to memory, input components, and output components. The memory includes computer-readable instructions executable by the processor to provide the device with, for example, spatial responsiveness, UI stabilization, network connectivity, image processing, user interface control, browser features, and/or the like. The input components may include a first input camera disposed in a proximal end of the device, a second input camera disposed in a distal end of the device, and a haptic interface to receive user inputs. Output components may include, for example, a projector, such as a pico projector, and a speaker.

An input camera on the distal end of the device may provide the device with input to gather information about the surface onto which the device is projecting, or is to project, an image. This information may in turn be used by the device to provide the user or other viewer with visual feedback for navigation of the projected image (e.g., a webpage). An additional input camera on the proximal end of the device at least provides the device with input pertaining to the user or other viewer, for example, the user or other viewer's image, identity, head/eye position relative to the device, and/or the like. Such data may be used to provide functionality to the device and/or value to a user of the device. For example, the user's or other viewer's image may be used for handheld video chat and/or for identity verification to restrict or control use of the device. As a further example, the user's or other viewer's eye/head position relative to the device may be used by the device to control the angle and perspective of the projected image to facilitate viewing.

In some embodiments, the device is able to detect its position and orientation with respect to a projection surface. The device may use this information in a spatially responsive manner, such as to fix projected content at a particular coordinate location on a projection space. Thus, in accordance with such embodiments, the content of the projected image may be larger than the projected portion of the content that is being viewed. For example, the user may have zoomed in on content. In accordance with these embodiments, the user may move, orient, and position the device to view different respective portions of such a fixed projected image, in effect uncovering these different respective portions. The user may use the haptic interface to navigate the fixed image and reveal other portions of the fixed image.

The device may also include Global Positioning System (GPS) functionality. GPS functionality may provide location information to the device, thereby enabling the device to present augmented projections which may be used to direct a user or other viewer to a desired location, provide the user or other viewer with identification information with respect to structures, streets, geographical features, and/or the like, or provide other similar location, navigation or orientation functionality.

### An Exemplary Wireless Device

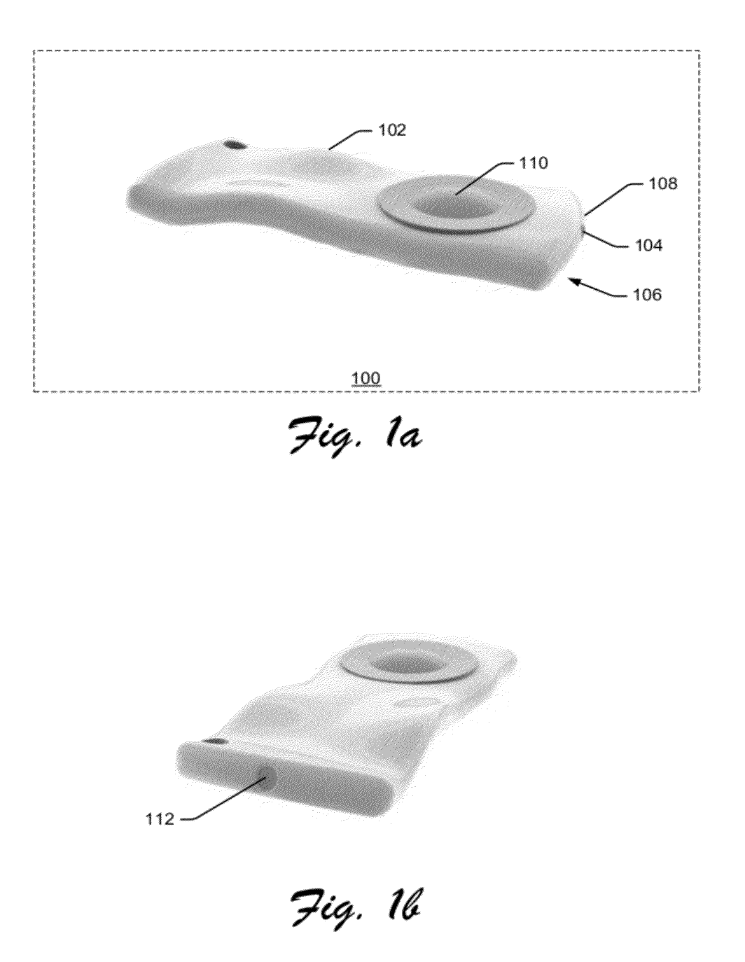

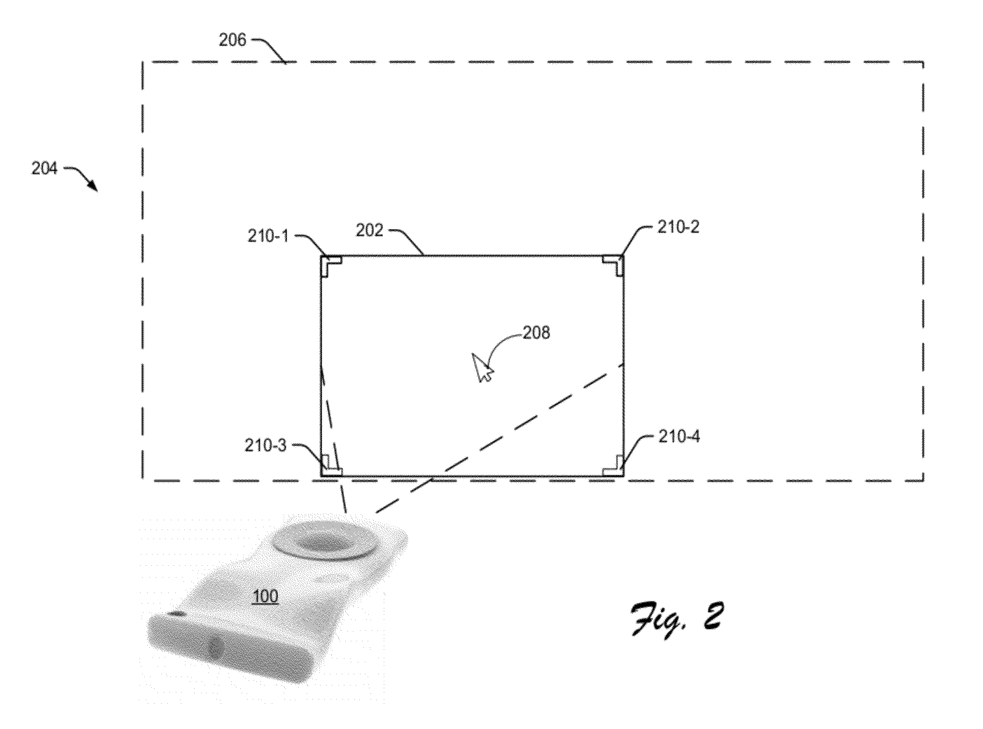

FIG. 1a shows aspects of an exemplary device 100 for presenting a projected user interface and interactive image to a user, according to one embodiment. As illustrated, a generally parallelepiped housing 102 of device 100 may be sized and ergonomically adapted for handheld and/or wearable use. Device 100 includes user interactive image projector 104 disposed in distal end 106 of device 100. Projector 104 may be any suitable projector sized for use in the present device, e.g., a pico projector, Micro-Electro-Mechanical Systems (MEMS)-based projector, or the like. End 106 is generally distal during normal use of device 100. Device 100 further includes a forward facing camera 108 disposed with respect to the distal end of the device. In one implementation, for example, camera 108 is an Active Pixel Sensor (APS), Charge Coupled Device (CCD), or the like. The forward facing camera may provide the device with input to gather information about the surface onto which the device is projecting, or is to project, an image. This information may in turn be used by the device to provide the user with visual feedback for navigation of the projected image.

In this implementation, device 100 includes user interface (UI) 110 (e.g., a haptic interface) such as the navigation directional control with section button (e.g., a directional pad). However, UI 110 can take any number of other forms, such as a joystick, roller ball, or any other direction and selection control. UI 110 may be used for control of device 100 and/or navigation of a projected user interactive image, in addition to, or rather then, user movement of device 100. UI 110 is shown disposed atop device housing 101, but a human interface may be otherwise integrated into the device.

FIG. 1b shows further exemplary aspects of a device 100 for presenting a projected user interface and interactive image to a user, according to one embodiment. As shown, 100 also includes a rearward facing camera 112 disposed with respect to the proximal end of the device. In one implementation, for example, camera 112 is an APS, CCD, or the like. This rearward facing camera at least provides the device with input pertaining to the user or other viewer(s). In one implementation, for example, the rearward facing camera provides the device with one or more types of information/characteristics to determine a user's or other viewer's image, identity, head/eye position relative to the device, and/or the like. Such data may be used to provide functionality to the device and/or value to a user of the device. For example, the user's or other viewer's image may be used for handheld video chat and/or for identity verification to restrict or control use of the device. As a further example, the user's or other viewer's eye/head position relative to the device may be used by the device to control the angle and perspective of the projected image to facilitate viewing.

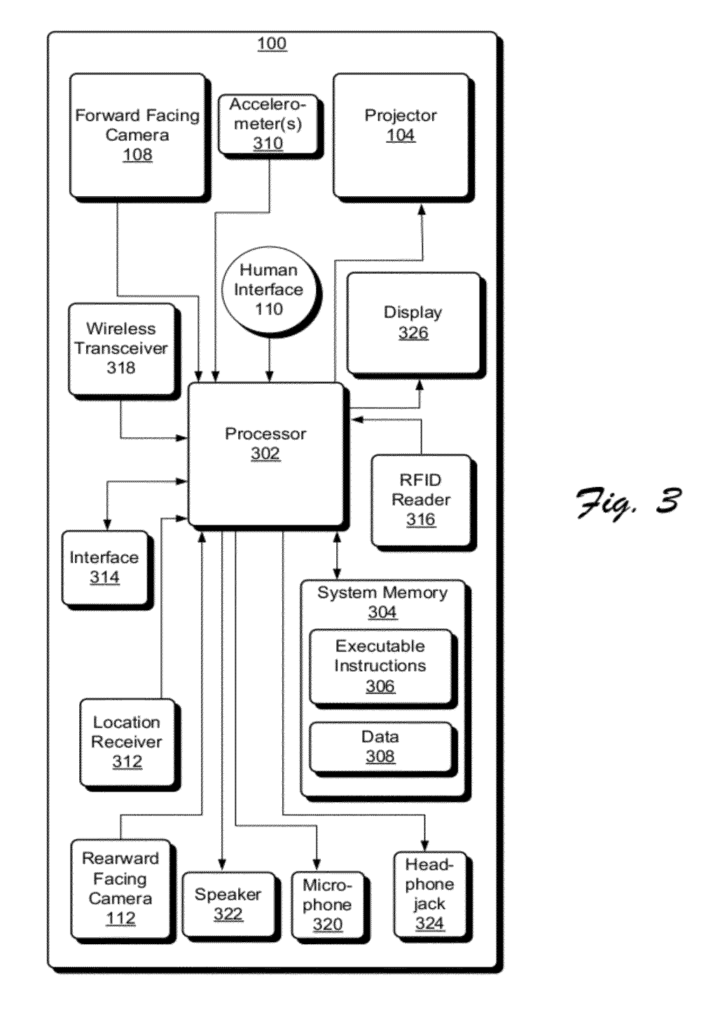

FIG. 2 shows an exemplary device 100 projecting a user interactive image 202 onto a surface 204 (e.g., a wall, etc.) according to various embodiments. In this example, the user interactive portion of the image is represented by a rectangular shape, although other geometrical shapes are also contemplated. As noted, the projected image may be a user interface (UI), a webpage of a website, a video, a photo, a photo album, or the like. As illustrated, projected user interactive image 202 may only be a portion of larger (virtual) image 206, shown using dashed lines. Device 100 may be operatively configured to lock a larger image 206 into a stationary position on the projection surface 204, while user navigation instructions received by the device may afford navigation of the portion of larger image 206 that is projected as user interactive image 202. The user may navigate larger virtual image 206 by moving projected user interactive image 202, which in effect uncovers or reveals a portion of larger image 206. Such navigation of larger virtual image 206 may be carried out through movement of device 100 relative to the projection surface. In another example, device 100 may also project a cursor 208 within image 202 to allow user selection of projected webpage links, or the like, in image 202, which may facilitate display of a subsequent user interactive image.

In one implementation, and to facilitate sensing a position and orientation of the projected image 202 on a projection surface 204, device 100 may project a set of registration marks 210 (e.g., 210-1 through 210-4) or the like onto the projection surface. Forward facing sensor/camera 108 (FIG. 1) is used by the device to sense the position and/or orientation of the registration marks. In this scenario, the device may modify projection of image 202 on the surface based on the detected position and/or orientation of the registration marks. Other embodiments may sense the position and/or orientation of a projection surface employing any number of methods, such as electromagnetic tracking, acoustic tracking, other optical tracking methodologies, mechanical tracking, or the like. Such tacking methodologies may employ electromagnetic signals, acoustic signals, optical signals, mechanical signals, or the like, respectively. More particularly, embodiments employing optical signals might emit an infrared signal using projector 106 onto projection surface 204 and sense the reflected infrared light using camera 108 to determine the relative distance and/or orientation of the projection surface. Acoustic methodologies might employ ultrasonic sound waves emitted from the device. The delay in their reflection may be measured and/or the reflected sound wave analyzed to determine the distance to the projection surface and/or its relative orientation. Alternatively, a passive methodology may be used to determine projection surface distance and/or orientation, such as by performing a passive analysis of an image of projection surface 204 (or projected image 202) that is entering camera 108, using phase detection or contrast measurement. Phase detection may be achieved by dividing the incoming light into pairs of images and comparing them. Contrast measurement may be achieved by measuring contrast within the image, through the lens of camera 108. Further, the device may employ information about a position, or change in position of the user and/or other viewer(s) to modify the image to provide a proper viewing alignment of projected image 202 with respect to the user and/or viewer(s). Such position information may be gathered and evaluated by the device: (a) using rearward facing camera 112, (b) determined by default device settings regarding, e.g., default viewer distance from a projection, and/or (c) provided via user inputs to the device (e.g., multiple viewers at 100 feet from projection).

FIG. 3 shows further exemplary aspects of device with projected user interactive image, according to one embodiment. In particular, FIG. 3 shows exemplary computing device components of the device 100 of FIGS. 1a, 1b, and 2. Referring to FIG. 3, device 100 includes, for example, one or more processors 302, system memory 304 and cache memory (not shown). System memory 304 may include various computer-readable media, such as volatile memory (e.g., random access memory (RAM)) and/or nonvolatile memory (e.g., read-only memory (ROM)). Memory 304 may also include rewritable ROM, such as Flash memory and/or mass storage devices such as a hard disk. System memory 304 includes processor executable instructions (program modules) 306 to perform the operations to project a user interactive image on a surface independent of the device, in addition to program data 308.

As illustrated in FIG. 3, and as described above in reference to FIG. 1a, FIG. 1b, and FIG. 2, processor(s) 302 is also operatively coupled to projector 104, interface 110, forward facing camera 108, and rearward facing camera 112. In one implementation, processor(s) 302 are also coupled to a projection surface position and orientation sensor, for example, which might be functionality associated with forward facing camera 108. In this exemplary implementation, device 100 further includes one or more accelerometers 310, gyroscopic devices, or the like, that may be used for sensing movement of device 100 and provide information about such movement, such as three dimensional direction, speed, acceleration, etc., to processor(s) 302. In turn, processor(s) 302 may use this motion information in conjunction with processor executable instructions 306 to facilitate navigation of projected image 202 (FIG. 2) and/or to facilitate other aspects of projection of the projected image, such as the locking of the displayed or virtual image(s) 206. Further, input from accelerometers 310 may be used to stabilize the user interactive image on the projection surface and/or to correct projection of image 202 for proper viewing from the perspective of the user or other viewer(s).

In one implementation, device 100 might include location receiver 312, such as a GPS receiver, or the like. Processor(s) 302, executing executable instructions 306, might use projector 104 to project routing and/or location information for presentation to a user or other viewer in accordance with input from location receiver 312 and/or inputs received from the user (e.g., a target destination, etc.).

In one embodiment, for example, device 100 includes other components such as hardware interface(s) 314 (e.g., a Universal Serial Bus (USB)), a Radio Frequency Identification (RFID) reader 316, wireless communication transceiver 318, and input/output (I/O) devices (e.g., a microphone 320, speaker(s) 322, and a headphone jack 324). Input to microphone 320, for example, may be used by processor(s) 302, employing processor executable instructions 306 from memory 304, for any number of functions in device 100. For example, voice input from the user or other viewer may be used during the above-discussed video communications, or to provide user input for navigation (e.g., voice recognition could be used for selection and/or to provide input in lieu of a keyboard). In another example, processor(s) 302, employing processor executable instructions 306 from memory 304, might output received voice input from the other party in a video communication, using speaker 322. In addition, a speaker 322 may be used to provide audio content accompanying user interactive image 202. As another example, speaker 322 might provide feedback to the user during navigation of user interactive image 202, (e.g., selection clicks, and the like). In yet another example, headphone jack 324 may be employed by the user (e.g., in lieu of speaker 322), particularly to provide stereo input accompanying a displayed image.

The embodiment of device 100 illustrated in FIGS. 1a, 1b and 2 is displayless in that illustrated device 100 does not itself have a screen, and is not connected to a monitor, or the like. Rather, device 100 of FIGS. 1a, 1b and 2, in effect, employs projector 104 and its projected user interactive image 202 as its sole display. However, embodiments of the present device may employ a physical display 326 operatively coupled to processor 302. Display 326 might be a LED display, OLED display, or other compact lightweight display well adapted for use in a wireless handheld device. Display 326 may present a user the same image as being projected by projector 104, or it may present a user another image, such as a information about the image being projected, navigation information, device status information, and/or so on.

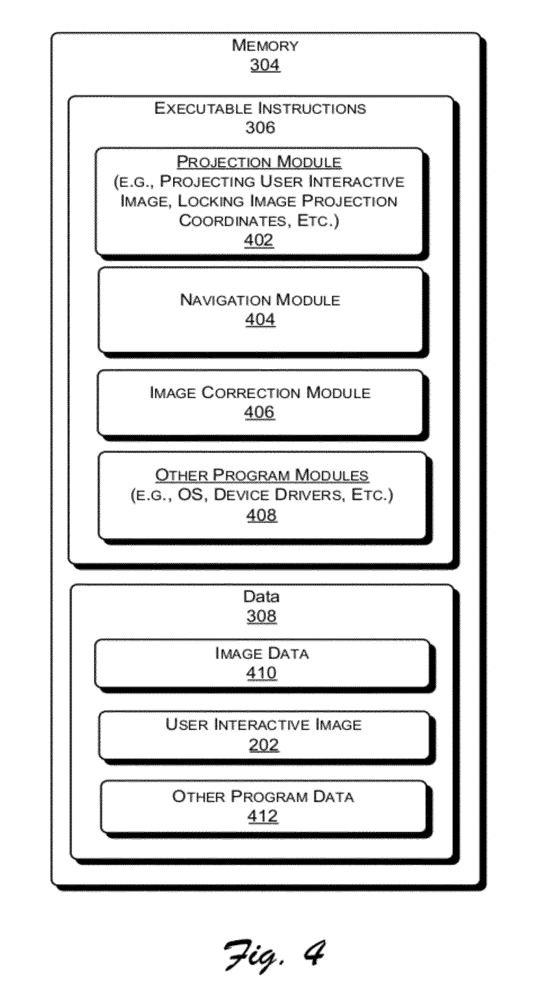

FIG. 4 is a diagrammatic illustration of contents of memory 304 of device 100 projecting a user interactive image 202 (FIG. 2), according to one embodiment. Processor executable instructions 306 included in memory 304 might include a projection module 402, a navigation module 404, image correction module 406, and other program modules such as an operating system (OS), device drivers, and/or so on. Projection module 402 comprises computer program instructions to project a user interactive image on a projection surface 206 (FIG. 2). Such a projection surface is independent of and spaced apart from device 100. In one implementation, the projection module includes computer executable instructions to lock a presented interactive image 202 into a stationary coordinate position on a projection surface.

Navigation module 404 is operatively configured to receive user input (shown as a respective portion of “other program data” 414) to mobile device 100 to navigate a projected user interactive image 202 in accordance with the user input. As used herein, references to “navigate” or “navigation” generally refer to moving about within the projected image, as one would a webpage or similar interactive image, and/or selection of various links, for movement from one page to another, and/or selection of buttons, boxes, or the like displayed in the image, for further interaction. The user navigation input might be movement of device 100 itself. In this latter scenario, the instructions might provide the aforementioned navigation in accordance with movement of the device relative to the locked user interactive image.

In one implementation, for example, movement of device 100 might move cursor 208 within image 202 to allow selection of projected webpage links, or the like, in image 202, which may facilitate display of a subsequent user interactive image. Additionally or alternatively, in accordance with such embodiments, projected user interactive image 202 may only be a portion of larger virtual image 206 (FIG. 2). The user may navigate larger virtual image 206 by moving projected user interactive image 202, in effect, uncovering or revealing a portion of larger image 206. Such navigation of larger virtual image 206 may be carried out through movement of device 100 relative to the projection surface.

Image correction module 406 includes computer program modules to correct image 202 for the position and/or orientation of the projection surface relative to device 100, particularly the focal plane and or projection centerline, of projector 104. Projector 104 may project registration marks 210 (FIG. 2), or the like onto the projection surface. Forward facing sensor/camera 108 may sense the position and/or orientation of registration marks 210. The projection of image 202 onto the surface 204 may be corrected based on the position and/or orientation of registration marks 210. Additionally or alternatively, image correction module 406 may use information, such as may be gathered using rearward facing camera 112 (or otherwise provided through default settings or user selections), about a position, or change in position of the user and/or other viewer(s), relative to the surface and/or the device itself. Such information may be used to correct a projected image to provide a proper viewing alignment of image 202 with respect to the user and/or viewer(s). For example, image correction module 406 may adjust parallax of an image to provide a viewer standing or seated beside a user of the device a properly aligned view of the projected image.

Program data 308, includes, for example, data that is pervasive or transitory. For example, memory 304 may store image data 408, such as photos, videos, etc, and/or memory 304 may act as a cache, storing interactive image 202 as data, which may be a webpage, and other program data such as final results, intermediate values, etc.

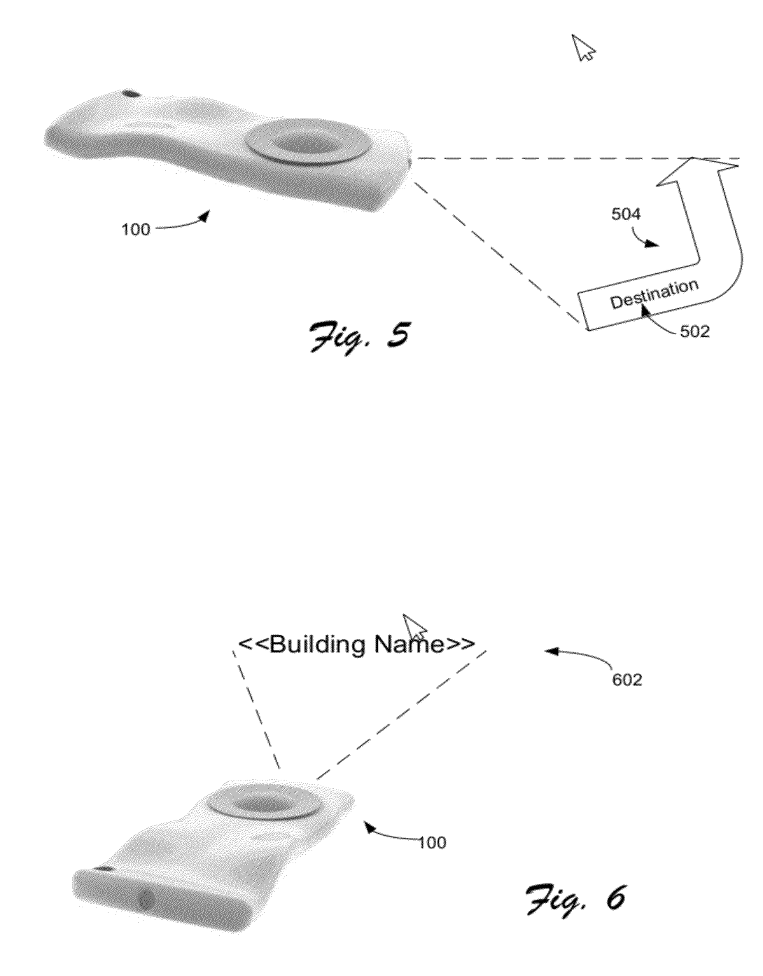

FIG. 5 is a diagrammatic perspective view of device 100 projecting routing instructions and/or information corresponding to a target destination or inquiry, according to one embodiment. As illustrated in FIG. 5, device 100 might project direction indicia 502 and/or routing indications, such as illustrated turn arrow 504. Indicia 502 could include the name of a destination, street names, distances to turns, direction of turns, distance to the destination, and the like. Such directions, for example, may be turn-by-turn directions presented to the user projected from device 100, changing as the user moves with device 100 along the indicated route.

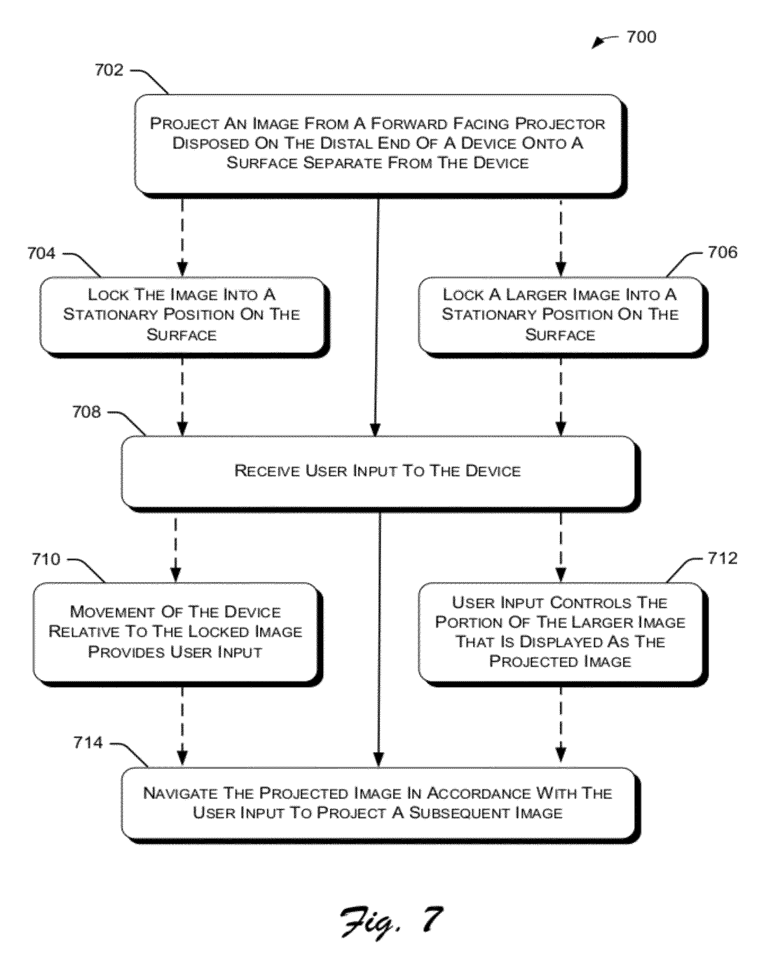

FIG. 6 is a diagrammatic perspective view of device 100 projecting identification indicia 601, according to one embodiment. For example, device 100 might project information about the object/subject comprising the surface onto the surface, or nearby. For example, processor(s) 302, executing memory-resident instructions, might project, using projector 104, indicia 602 on a projection surface associated with an object, wherein the indicia identifies the object, such as a building's name, the name of a roadway (i.e., project the name of a street onto the street itself), the name of a person, etc. In addition, device 100 might employ input from other sources, such as RFID information, received via RFID reader 316, to provide projection surface labels.

For purposes of illustration, various components (including program modules) are shown herein as discrete blocks, although it is understood that such components and corresponding independent and distinct logic may be integrated or implemented in more or less or different components or modules. Alternatively, the systems and procedures described herein can be implemented in hardware, or a combination of hardware, software, and/or firmware. For example, one or more Application Specific Integrated Circuits (ASICs) can be programmed to carry out one or more of the systems and procedures described herein.

### Exemplary Procedures for Projecting a User Interactive Image

FIG. 7 shows example procedure 700 for display and interaction with an interactive projected image, according to one embodiment. At block 702, a user interactive image is projected from a forward facing projector (104) disposed on the distal end of a device onto a surface (204) independent from the device. To facilitate navigation, the projected user interactive image may be locked into a stationary position on the surface at block 704. Alternatively or additionally, the projected user interactive image may only be a portion of a larger image and the larger image may be locked in a stationary position relative to the surface at block 706. At block 708, the exemplary procedure receives user input to the device. As discussed above, this user input may be movement of the device and/or may be provided via a human interface incorporated into the device. In particular, at block 710 movement of the device relative to the user interactive image locked at block 704 may provide the user input. Where the projected user interactive image is a part of larger virtual image, particularly a larger image locked at 706, the user input may, at block 712, control the portion of the larger image that is displayed as the projected user interactive image. This user input may be movement of the device, which provides the aforementioned uncovering of different respective portions of the larger image. The projected user interactive image is navigated at block 714 in accordance with the user input to project a subsequent user interactive image.

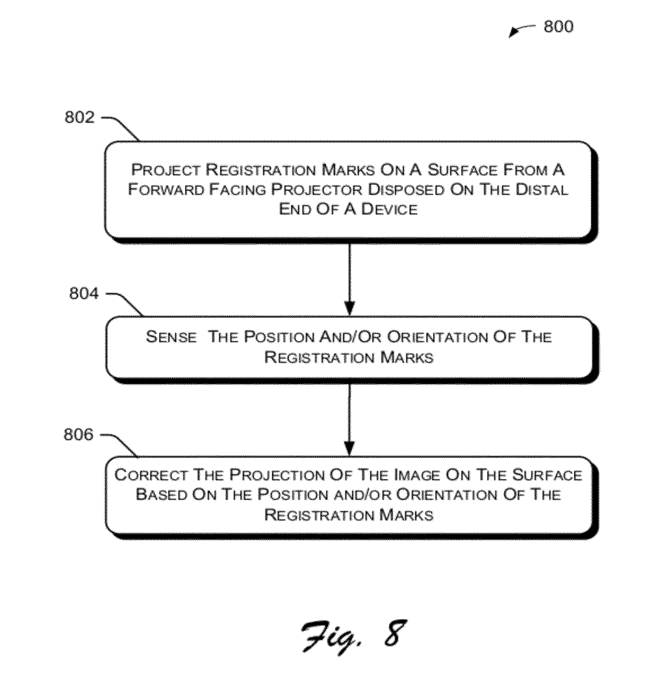

FIG. 8 shows an exemplary procedure 800 for projecting a user interactive image, according to one embodiment. Projecting a user interactive image from a device may further comprise sensing a position and orientation of the projection surface. Such sensing may be carried out by projecting registration marks (210) on the surface (204) at 802 using the device projector (104), and sensing the position and/or orientation of the registration marks at 804, such as through the use of a forward facing sensor/camera (108) which may be housed in distal end (106) of the device (100). Then, at 806, the projection of the image (202) on the surface may be corrected based on the position and/or orientation of the registration marks. This correction may be performed by processor(s) (302) executing image correction instructions (406) resident in device system memory (304).

FIG. 9 shows example procedure 900 for projecting a user interactive image, according to one embodiment. This procedure may be used in conjunction with the procedure outlined in FIG. 8. Projecting a user interactive image from a device, such as discussed above at step 702 of procedure 700, may further comprise sensing or otherwise determining a position and orientation of the user or other viewer(s) at 902, such as using rearward facing camera 112 to capture the head and/or eye position or orientation of a particular viewer, with respect to device 100. Such sensing may be performed in response to movement of the device, the viewer or both, relative to the projection surface. The projection of the image on the surface is corrected at 904 based on the position and orientation of the viewer(s) relative to the position and orientation of the projection surface. For example, in one embodiment, the projection may be corrected for the angle, or change in angle, of the viewer, particularly the viewer's head and/or eyes, relative to the position and orientation of the projection surface and/or the device. In particular, parallax of a projected image may be corrected to provide the user, and/or one or more other viewers, a properly aligned image from the user's and/or viewers' perspective (e.g., viewing from a distance, from an angle, etc.)

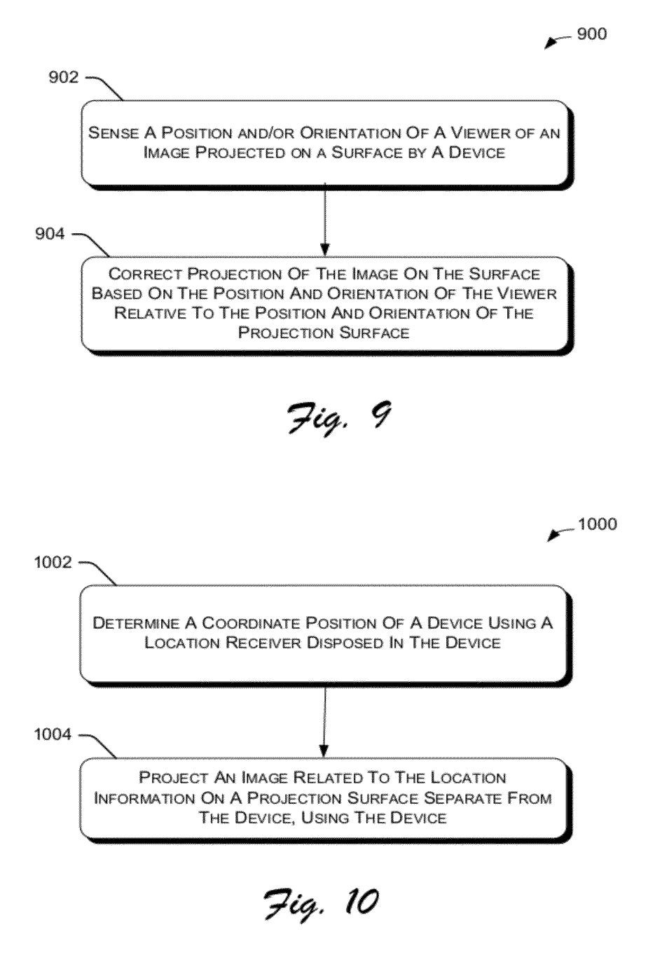

FIG. 10 shows example procedure 1000 for projecting location information, according to one embodiment. A coordinate position of a device is determined at 1002, such as by using a location receiver, such as a GPS receiver, in the device. The device projects an image related to the location information at 1004 onto a projection surface separate from the device. This image may include directions in accordance with the coordinate position and/or information about the object/subject of which the surface is a part.

### CONCLUSION

Although systems and methods for devices using a projected user interactive image (e.g., a user interface) have been described in language specific to structural features and/or methodological operations or actions, it is understood that the implementations defined in the appended claims are not necessarily limited to the specific features or actions described. Rather, the specific features and operations of the device using a projected user interactive image are disclosed as exemplary forms of implementing the claimed subject matter.

1. A mobile device comprising:
a projector disposed in a distal end of the mobile device from the user;
a processor operatively coupled to the projector; and
a memory operatively coupled to processor, the memory including processor executable instructions to:
(a) project at least a portion of an image on a projection surface separate from the mobile device;
(b) lock at least a portion of the image with respect to coordinates on the projection surface;
(c) receive user input to the mobile device; and
(d) interface, responsive to receipt of the user input, with the image in accordance with the user input.

2. The mobile device of claim 1 wherein the device does not have a display.

3. The mobile device of claim 1 wherein the image is a user interactive image.

4. The mobile device of claim 1 wherein the user input comprises movement of the mobile device.

5. The mobile device of claim 1 wherein, responsive to receipt of the user input, the processor executable instructions further include instructions to display a next image.

6. The mobile device of claim 1, further comprising a user interface (UI) to provide the user input via a directional control and a selection button.

7. The mobile device of claim 1, further comprising a sensor operatively configured to provide the device with projection surface position and orientation information, the sensor being proximally disposed on a distal portion of the device, and wherein the processor executable instructions to project the image utilize the information to correct presentation of the image.

8. The mobile device of claim 1, further comprising a rearward facing camera operatively configured to capture characteristics pertaining to a viewer of the image.

9. The mobile device of claim 8 wherein the characteristics pertain to one or more of a captured image of the viewer, information to evaluate identity of the viewer, and viewer head/eye position relative to the device.

10. The mobile device of claim 9 wherein the processor executable instructions further comprise instructions to correct projection of the image based on the viewer's head/eye position.

11. A method at least partially implemented by a handheld projection device, the method comprising:
projecting, by the handheld projection device, an image onto a surface independent of the handheld projection device, the projecting being from a forward facing projector disposed on a distal end of the handheld projection device;
locking projection coordinates, by the handheld projection device, of the projected image with respect to the surface;
receiving, by the handheld projection device, user input; and
interfacing, by the handheld projection device, with the projected image based on the user input.

12. The method of claim 11, further comprising locking a projected cursor relative to the surface and navigating the projected image by moving the projection of the image in accordance with movement of the handheld projection device relative to the locked cursor.

13. The method of claim 11 wherein the projected image is a portion of a larger image, and wherein the method further comprises locking the larger image into a stationary position relative to the surface, and the user input controls the portion of the larger image that is displayed as the projected image.

14. The method of claim 11, further comprising:
sensing a position and orientation of the user; and
correcting projection of the image on the surface based on the position and orientation of the user relative to the position and orientation of the projection surface.

15. The method of claim 11, further comprising:
sensing a position and orientation of the projection surface; and
correcting projection of the image on the surface based on position and orientation of the projection surface.

16. The method of claim 15 wherein the projecting further comprises projecting registration marks on the surface, and wherein the sensing further comprises sensing the position and orientation of the registration marks, and wherein the correcting further comprises correcting the projection of the image on the surface based on the position and orientation of the registration marks.

17. A mobile communications device comprising:
an image projector disposed in an end of the mobile communications device, distal from the user;
a location receiver;
a processor operatively coupled to the projector and the location receiver; and
processor readable memory operatively coupled to processor, the memory including processor executable instructions to receive location information from the location receiver and to project an image related to the location information on a projection surface separate from the mobile communications device.

18. The mobile communications device of claim 17 wherein the image related to the location information includes information about a subject associated with the projection surface.

19. The mobile communications device of claim 17 wherein the location information is a current location of the mobile communications device and the image related to the location information includes directions to another location distant from the current location of the mobile communications device.

20. The mobile communications device of claim 17 wherein the location information is a current location of the mobile communications device and the image related to the location information includes directions to a target location specified by an entity in communication with the mobile communications device.
